(19) United States
(12) Patent Application Publication
(10) Pub. No.: US 2011/0286058 A1
(43) Pub. Date: Nov. 24, 2011

(54) SCANNING METHOD OF SCANNING APPARATUS AND SCANNING APPARATUS

(75) Inventors: Ming-Jie Zhao, Suzhou (CN); Xian-Jun Wang, Suzhou (CN); Jian-Chun Yu, Suzhou (CN)

(73) Assignee: QISDA (SUZHOU) CO.,LTD, Suzhou (CN)

(21) Appl. No.: 12/783,689

(22) Filed: May 20, 2010

(30) Foreign Application Priority Data
May 20, 2010 (CN) 200910145273.4

(51) Int. Cl. H04N 1/04

(52) U.S. Cl. 358/498

(57) ABSTRACT

A scanning method of scanning apparatus and a scanning apparatus are provided. Firstly, when the scanning apparatus is in the default reflective document scanning state and a document is placed in the scanning apparatus, the scanning apparatus automatically activates reflective document scanning function to perform scanning. Next, a document holder is disposed in the feeding entrance of the scanning apparatus, wherein after the scanning apparatus activates the transmissive document scanning state and the document is placed in the document holder, the scanning apparatus automatically activates transmissive document scanning function to perform scanning. The scanning method automatically activates corresponding scanning function without performing document recognition, incurs lower power consumption, produces fast recognition, and is applicable to various scanning apparatuses having both reflective document and transmissive document scanning function. The scanning apparatus has well-designed structure, incurs lower manufacturing cost, and does not require complicated light emitting element and light measuring element.

This application claims the benefit of People's Republic of China application Serial No. 200910145273.4, filed May 20, 2009, the subject matter of which is incorporated herein by reference.

### BACKGROUND OF THE INVENTION

1. Field of the Invention

The invention relates in general to a technology of scanning transmissive document and reflective document, and more particularly to a scanning method of scanning apparatus having both transmissive document scanning function and reflective document scanning function and a scanning apparatus.

2. Description of the Related Art

Scanner has become one of indispensible electronic products to people in both their work and everydayness. The scanner, being an important computer I/O device, mainly uses a light source to provide a light source module for scanning a document. Next, the image of a reflective or transmissive document is received by a reception device during the process of scanning. Then, an image signal of the document is obtained by a picture sensor and converted into a digital signal through photo-electrical conversion, and then the digital signal is transmitted to the computer for image displaying or image processing. Normally, the general purpose scanner is used for scanning a reflective document. That is, a light is radiated onto the original document and then the reflected light is received by a photo-sensing element. Then, the reflected light is further converted and stored in the computer in the form of digital data. However, when the general purpose scanner is used for scanning a transmissive document (such as film), as the transmissive document is transmissive and cannot reflect the light, a transmissive light source is required to radiate a light which passes through the film and radiates on the photo-sensing element.

Currently, the scanning apparatus having both reflective document scanning function and transmissive document scanning function achieves the switch of the two scanning functions by adding several function conversion keys or by operating the program of a computer connected to the scanning apparatus. However, such method cannot be adapted in small-sized portable scanner having no extra space for the disposition of function conversion keys. Also, the user tends to neglect the manual operation of the function conversion keys and result in erroneous selection of scanning function. The automatic recognition of document and the activation of the scanning apparatus compatable with the document are determined by the sensing element according to the intensity of the light passing through the document after the document enters the scanning apparatus. If the light intensity sensed by the sensing element is smaller than a threshold, then the document is determined as a reflective document, and the scanning apparatus immediately activates reflective document scanning function to scan the reflective document. If the light intensity sensed by the sensing element is larger than a threshold, then the document is a determined as a transmissive document, and the scanning apparatus immediately activates transmissive document scanning function to scan the transmissive document.

The scanning apparatus with automatic document recognition and the scanning method thereof have several problems. Firstly, as the light emitting element and the sensing element have to be in the on state all the time, high power consumption occurs. Next, the sensitivities of the light emitting element and the sensing element deteriorate along with the time of use, and errors in document recognition may easily occur. Furthermore, as the fed document needs to be recognized first before corresponding scanning function can be activated to perform scanning, the scanning speed is thus largely reduced.

### SUMMARY OF THE INVENTION

The invention provides a scanning method which automatically activates corresponding scanning function without performing document recognition. The method incurs lower power consumption, produces fast recognition, and is applicable to various scanning apparatuses having both reflective document scanning function and transmissive document scanning function, particularly, the multi-functional scanning of portable scanning apparatus.

The invention further provides a scanning apparatus which automatically activates corresponding scanning function without performing document recognition. The scanning apparatus has well-designed structure, incurs lower manufacturing cost, and does not require complicated light emitting element and light measuring element.

The technology adopted in the invention is disclosed below:

A scanning method of a scanning apparatus being a sheet-fed scanning apparatus having both reflective document scanning function and transmissive document scanning function is provided, wherein the scanning method comprises:

In a default state of the scanning apparatus being in a reflective document scanning state, placing a document in the scanning apparatus and then the scanning apparatus automatically activates the reflective document scanning function for performing scanning;

Inserting a document holder to the feeding entrance of the scanning apparatus, and then the scanning apparatus activates a transmissive document scanning state and automatically activates the transmissive document scanning function to perform scanning after a document is placed in the document holder.

To put it in details, the scanning method further comprises:

Obtaining a sensing signal indicating that the document is already fed in and activating the reflective document scanning element by the scanning apparatus in the default state to perform reflective document scanning function after a document is placed into the scanning apparatus.

In an embodiment of the invention, the scanning method further comprises:

Activating an activating member by the document holder after the document holder is placed in the feeding entrance of the scanning apparatus to further activate the scanning apparatus being in the transmissive document scanning state, wherein after the document is placed in the document holder, the document activates a sensing element and the scanning apparatus activates a transmissive document scanning element to perform transmissive document scanning function.

In an embodiment of the invention, the document holder has a hard insertion end disposed at the feeding entrance of the scanning apparatus, wherein the hard insertion end activates an activating member, which activates the transmissive document scanning function.

The invention provides a scanning method of scanning apparatus, wherein the scanning apparatus is a sheet-fed scanning apparatus having both reflective document scanning function and transmissive document scanning function. The scanning method comprises the following steps:

Activating the scanning apparatus which is in a default reflective document scanning state;

Sensing by the scanning apparatus to determine whether a document holder is disposed in a feeding entrance;

If there is no document holder inserted into the feeding entrance, the scanning apparatus is determined as the reflective document scanning state, and when the scanning apparatus obtains a sensing signal indicating that the document is already fed in, the scanning apparatus activates a reflective document scanning element to perform the reflective document scanning function;

Automatically setting the scanning apparatus to be in the transmissive document scanning state if there is a document holder inserted into the feeding entrance, wherein when the scanning apparatus obtains the sensing signal indicating that the document is already fed in, the scanning apparatus activates a transmissive document scanning element to perform transmissive document scanning function.

The invention provides another scanning method of scanning apparatus, wherein the scanning apparatus is a sheet-fed scanning apparatus having both reflective document scanning function and transmissive document scanning function. The scanning method comprises the following steps:

In the default state, the scanning apparatus being in a reflective document scanning state, inserting a document holder into the feeding entrance of the scanning apparatus, and after the scanning apparatus activates a transmissive document scanning state and a document is placed in the document holder, the scanning apparatus automatically activates the transmissive document scanning function to perform scanning;

Placing a reflective document in a carrier having a scanning recognition mark when scanning the reflective document, and when the scanning apparatus obtains the scanning recognition mark, the scanning apparatus activates the reflective document scanning function.

The invention provides a scanning apparatus having a reflective document scanning element and a transmissive document scanning element, wherein the scanning apparatus comprises:

A set of feeding assembly comprising a number of feeding rollers and corresponding driven rollers;

A document holder whose one end has a transmissive document insertion portion and the other end has a hard insertion end;

An activating mechanism disposed in one side of the feeding assembly;

Wherein, when the document holder is not inserted into the feeding assembly, the scanning apparatus is in a reflective document scanning state, and after the hard insertion end of the document holder is disposed in the feeding assembly, the document holder activates the activating mechanism for enabling the scanning apparatus to activate a transmissive document scanning function.

In an embodiment of the invention, the activating mechanism, being a photo-electrical activating mechanism or a mechanical activating mechanism, is linked to a sensing element which is connected to a driving control unit of the scanning apparatus.

The activating mechanism comprises a flexible extension portion whose one end is located in a document holder inserting region at one side of the feeding assembly, wherein after the document holder is disposed in the flexible extension portion, the flexible extension portion is pressed downward to activate the sensing element to generate a sensing signal.

In another embodiment of the invention, the document holder is a transmissive document holder whose transmissive document insertion portion has a transmissive document upper stopper, wherein a recess is disposed under the transmissive document upper stopper and matches the feeding rollers, and when the document holder is disposed in the feeding assembly, the feeding rollers and the transmissive document upper stopper together hold the transmissive document.

The driven feeding rollers parallel to the feeding rollers are disposed on the lower end surface of the transmissive document upper stopper, and when the document holder is disposed in the feeding assembly, the feeding rollers and the driven feeding rollers together hold the transmissive document.

In yet another embodiment of the invention, the scanning apparatus further has a feeding entrance on which a document holder insertion portion is disposed, and the feeding assembly corresponding to the feeding entrance has a matching portion corresponding to the hard insertion end of the document holder.

In yet another embodiment of the invention, the scanning apparatus have two sets of feeding assembly in parallel.

Unlike the conventional method which adds a light emitting element and a light intensity sensing element, the scanning method of scanning apparatus of the invention enables the scanning apparatus to automatically recognize the desired scanning function by adding a document holder. In the default state, that is, when there is no document holder inserted into the feeding entrance of the scanning apparatus, the scanning apparatus is in the reflective document scanning function state and is capable of performing ordinary non-transmissive document scanning function. If a to-be-scanned document is placed, then the reflective document scanning element performs reflective document scanning function. When a document holder is disposed in the feeding entrance of the scanning apparatus, the scanning apparatus is in the transmissive document (such as film) scanning function state. Meanwhile, if a transmissive document is placed through the document holder, then the transmissive document scanning element activates transmissive document scanning function.

As the transmissive document such as film is single-sheet or continuous scanning document, the transmissive document can be smoothly or steadily fed into the feeding entrance of the scanning apparatus with the use of a document holder. The scanning method enables the scanning apparatus to automatically recognize the target scanning function to fit the needs in operation through particular functions of the document holder, not only simplifying the process of operation and increasing the intelligence of operation but also avoiding the extra cost of adding a document recognition device to the scanning apparatus.

The scanning apparatus can implement document holder recognition through a mechanical element or a photo-electrical element. As the document holder is a carrier with a hard insertion end, when the hard insertion end is inserted into the feeding entrance of the scanning apparatus, that is, between the feeding roller sets of the scanning apparatus, the hard insertion end activates the mechanical element or the photo-electrical element for enabling the scanning apparatus to determine whether the document holder is disposed in the feeding entrance.

The invention has many advantages exemplified below: The scanning method automatically activates corresponding scanning function without performing document recognition, incurs lower power consumption, produces fast recognition, and is applicable to various scanning apparatuses having both reflective document scanning function and transmissive document scanning function, particularly, the multi-functional scanning of portable scanning apparatus. The scanning apparatus has well-designed structure, incurs lower manufacturing cost, and does not require complicated light emitting element and light measuring element.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing the steps of an embodiment of a scanning method of the invention;

FIG. 2 shows a structural diagram of the scanning apparatus of an embodiment of the scanning method of the invention;

FIG. 3 shows a scanning state of an embodiment of the scanning method of the invention;

FIG. 4 shows another scanning state of an embodiment of the scanning method of the invention;

FIG. 5 shows a cross-sectional view of the scanning apparatus of an embodiment of the scanning method of the invention in a reflective document scanning state;

FIG. 6 shows a cross-sectional view of the scanning apparatus of an embodiment of the scanning method of the invention in a transmissive document scanning state;

FIG. 7 shows a 3-D structural diagram of an embodiment of a document holder of the scanning apparatus of the invention;

FIG. 8 shows an application of an embodiment of the document holder of the scanning apparatus of the invention; and

FIG. 9 shows an application of another embodiment of the document holder of the scanning apparatus of the invention.

### DETAILED DESCRIPTION OF THE INVENTION

The invention provides a scanning method of scanning apparatus applicable to multi-functional sheet-fed scanning equipment having both reflective document scanning function and transmissive document scanning function. The scanning apparatus can be small-sized portable scanning equipment such as a name card scanner.

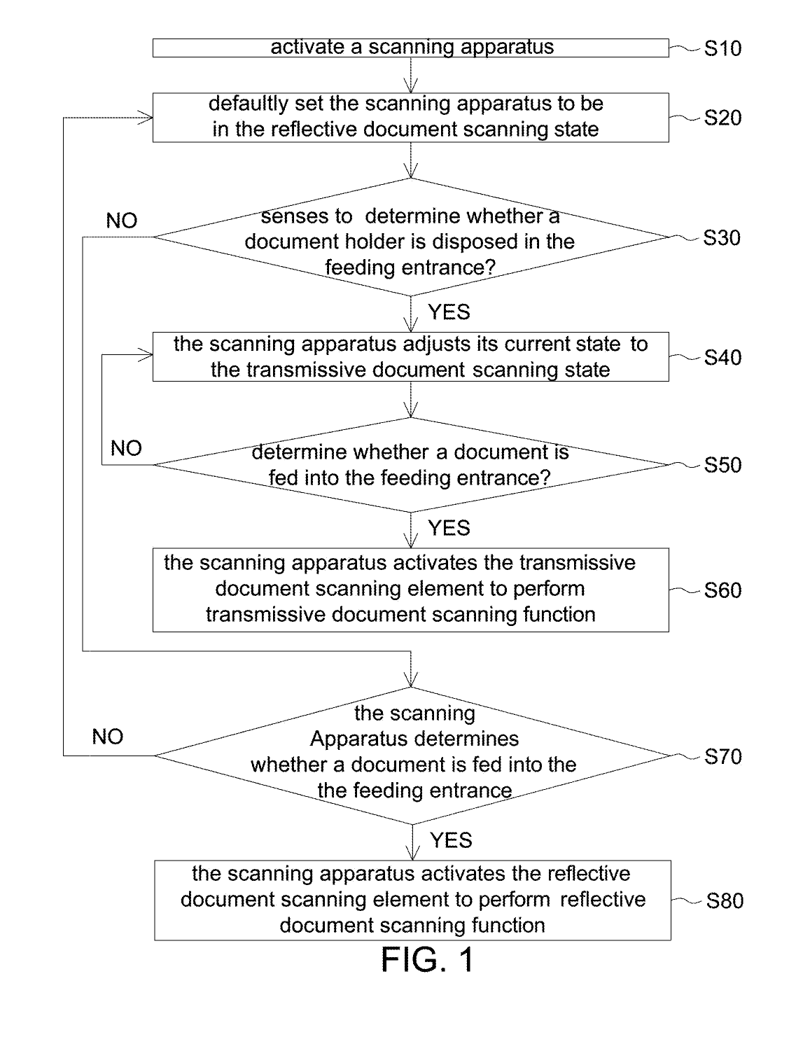

The details of the scanning method are disclosed in FIG. 1. As indicated in FIG. 1, after the scanning apparatus is activated, the scanning apparatus is defaultly in the reflective document scanning state as indicated in step S10 and step S20. When a to-be-scanned document is inserted into the feeding entrance of the scanning equipment, the scanning apparatus automatically performs reflective document scanning function without performing the setting of scanning function. The details of the scanning step are disclosed below: In the default state, the scanning apparatus first senses to determine whether a document holder is disposed in the feeding entrance as indicated in step S30. If there is no document holder, then the scanning apparatus determines whether a document is fed into the feeding entrance as indicated in step S70. If there is a document fed into the feeding entrance, then the scanning apparatus activates the reflective document scanning element to perform reflective document scanning function as indicated in step S80. If there is no document fed into the feeding entrance, then the scanning apparatus is still in the default state, that is, the reflective document scanning state.

As indicated in step S40, when the scanning apparatus senses that there is a document holder inserted into the feeding entrance, the scanning apparatus adjusts its current state to the transmissive document scanning state. Then, the method proceeds to step S50, whether a document is fed into the feeding entrance is determined. If it is determined that a document is fed into the feeding entrance, then the scanning apparatus performs step S60, that is, the scanning apparatus activates the transmissive document scanning element to perform transmissive document scanning function.

In each of the above mentioned steps, the operation of activating the reflective document scanning element or the transmissive document scanning element can be automatically performed by the scanning apparatus or manually performed by the operator, and such difference does not affect the scanning apparatus in recognizing or determining which of transmissive document scanning function and reflective document scanning function is to be used.

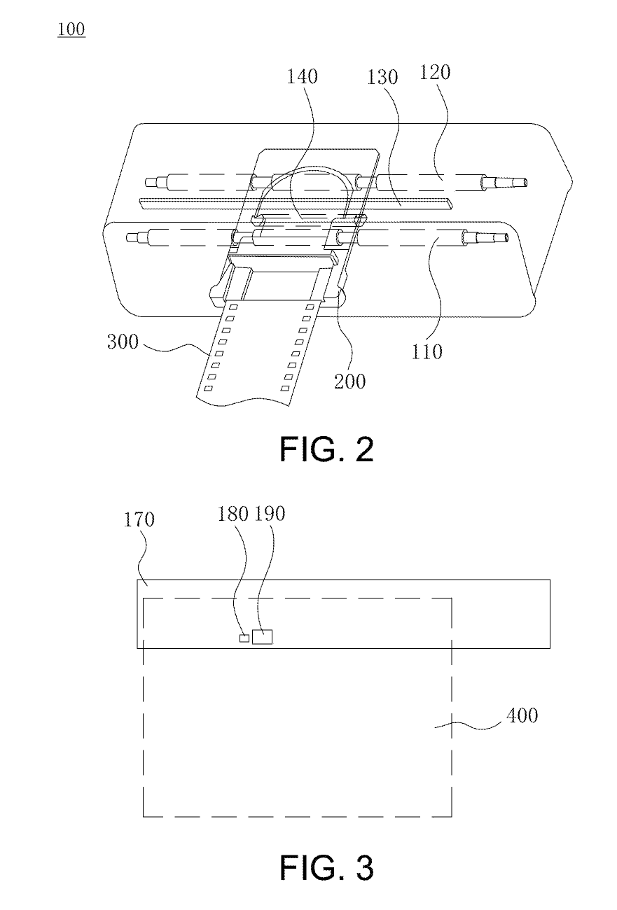

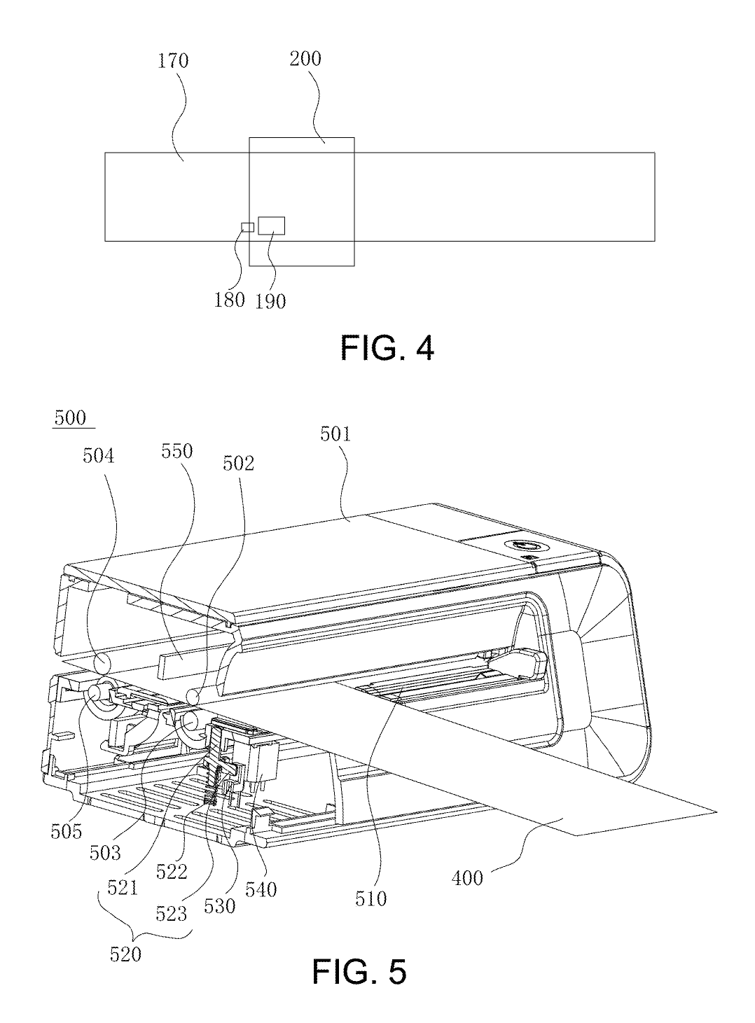

As indicated in FIG. 2, the scanning apparatus 100 used in the scanning method is a multi-function sheet-fed scanning equipment having both reflective document scanning function and transmissive document scanning function, and comprises two sets of feeding rollers 110 and 120 disposed in parallel. A scanning element 130 is disposed above the feeding platform, and a transmissive scanning light source 140 is disposed under the feeding platform. A document holder 200, such as a scanning carrier of the transmissive document 300, can be inserted between the feeding rollers. As indicated in FIG. 3, an activating member 180 and a sensor 190 are disposed on the scanning platform 170 of the scanning apparatus, wherein the activating member 180, disposed below the surface level of the scanning platform 170, is activated to produce corresponding signal only when the document holder is disposed in the scanning apparatus. Defautly, the scanning apparatus is in the reflective document scanning state, and after the reflective document 400 is placed on the scanning platform 170 and the sensor 190 senses that a document is fed into the scanning apparatus, the reflective document scanning element is automatically activated to perform reflective document scanning function. As indicated in FIG. 4, after a document holder is disposed in the feeding entrance of the scanning apparatus, the hard insertion end of the document holder 200 activates the activating member 180. Meanwhile, the scanning apparatus is automatically adjusted to the transmissive document scanning state, and the sensor 190 still can be used to determine whether a transmissive document is fed into the scanning apparatus and activate the transmissive document scanning element to perform scanning.

In the abovementioned embodiment, the scanning apparatus can determine whether a document holder is disposed in the feeding entrance by disposing a mechanical or photo-electrical activating member at the document holder insertion portion of the feeding entrance. That is, after the document holder is disposed in the feeding entrance of the scanning apparatus, the document holder activates the activating member so that the scanning apparatus obtains a signal indicating that the document holder is disposed in the feeding entrance.

In the abovementioned embodiment, the scanning method of scanning apparatus is predetermined, but in another embodiment of the scanning method, the scanning apparatus can be defaultly set to be in the transmissive document scanning state. If a document holder is disposed in the feeding entrance of the scanning apparatus, then the scanning apparatus activates the transmissive document scanning state. After a document is placed in the document holder, the scanning apparatus automatically activates transmissive document scanning function to perform scanning. During the process of scanning a reflective document, the reflective document is placed in a carrier having scanning recognition mark, and after the scanning apparatus obtains the scanning recognition mark during the process of scanning, reflective document scanning function is activated.

The scanning apparatus can be a small-sized portable scanning equipment, such as a mini scanning equipment like a name card scanner. As indicated in FIG. 5, two sets of feeding assembly are disposed in the housing 501 of the scanning apparatus 500, wherein the two sets of feeding assembly are disposed on the scanning platform 510 in parallel for providing a power to feed the to-be-scanned document. The feeding assembly can have two sets respectively composed of the feeding rollers 503 and 505 and the driven rollers 502 and 504. The feeding assembly can be implemented by the same feeding rollers used in the sheet-fed the scanning apparatus, and the structure of the feeding assembly does not affect the implementation of the technology of the invention.

A scanning element 550 is disposed above the scanning platform 510 for scanning the fed-in document, wherein the scanning platform further has a transmissive scanning light source, which assists the scanning element 550 to perform transmissive scanning function after the transmissive scanning light source is activated. An activating member 520 is disposed under the scanning platform 510. An activating switch 521, located at the top end of the activating member 520, is disposed in a recess of the activating platform 510, wherein the document fed-in through the feeding entrance does not touch the top-end activating switch 521. An elastic supporting portion 522 is disposed at the lower end of the activating member, wherein the elastic supporting portion 522 can be implemented by a spring fixed on the housing of the scanning apparatus for providing the top-end activating switch with an elastic restoring force. An interruption portion 523 is disposed on the horizontal extension of the activating member, wherein the interruption portion 523 is located at a sensing region of an interruption sensor 530. A photo-electrical the sensor 540 is further disposed under the scanning platform for sensing whether there is any document fed to the scanning position.

As indicated in FIG. 5, defaultly, the scanning apparatus is in the reflective document scanning state. If a document is fed to the scanning platform from the feeding entrance of the scanning apparatus, then the feeding rollers perform document feeding. The document fed-in from the scanning platform does not activate the activating member 520, and when the photo-electrical sensor of the scanning apparatus senses that the edge of the document enters the scanning region, the scanning element 130 activates reflective document scanning function to perform scanning.

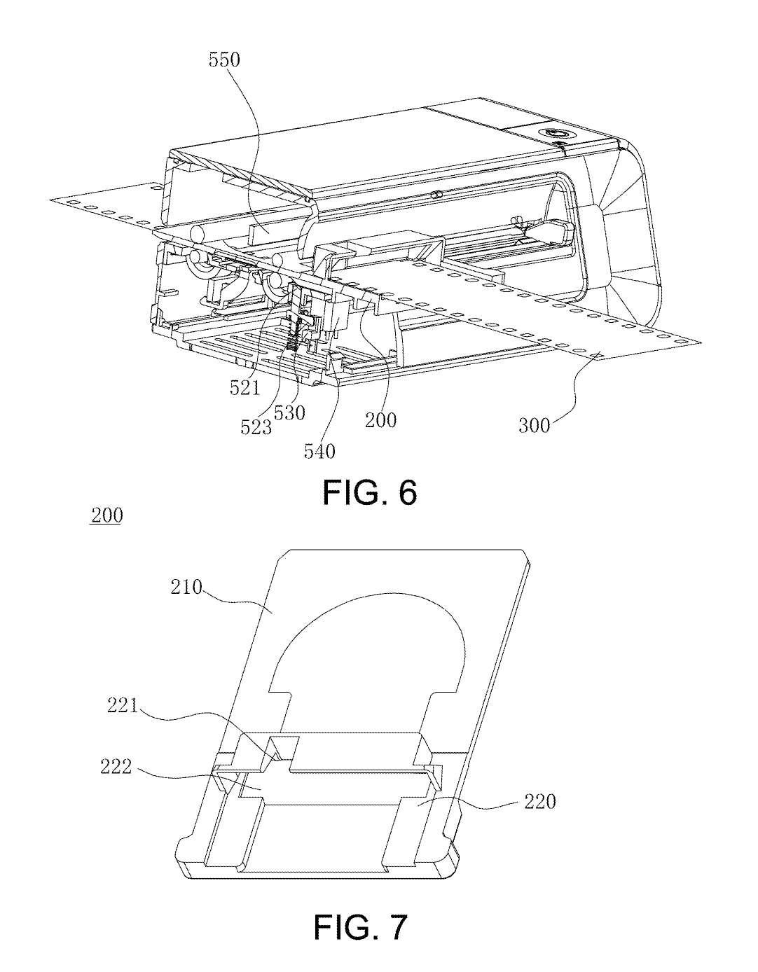

As indicated in FIG. 6, the scanning apparatus further comprises a document holder 200. The document holder 200 is a transmissive document carrier made from a polymer material, wherein one end of the document holder 200 has a transmissive document insertion portion, and the other end has a hard insertion end. After the hard insertion end is inserted into the feeding entrance of the scanning apparatus, the hard insertion end is located at the document holder inserting region on the scanning platform, and the bottom of the document holder touches the activating switch 521 located at the top end of the activating member, so that the activating member compresses the elasticity supporting portion to move downward. The interruption portion 522 activates the interruption sensor 530 to generate a signal, which is transmitted to the driving control unit of the scanning apparatus for setting the scanning apparatus to be in the transmissive document scanning state. After the transmissive document is fed to the scanning platform through the document holder, the photo-electrical sensor 540 still can be used to sense whether the front end of the document enters the scanning position so as to determine the timing for activating the transmissive document scanning element to perform transmissive scanning.

The activating member adopted in the scanning apparatus is a mechanical activating member, but the invention is not limited thereto. The photo-electrical activating member can also implement the determination of whether a document holder is disposed in the feeding entrance of the scanning apparatus.

As indicated in FIG. 7, the document holder 200 used in the scanning apparatus can be made from a polymer material and formed in one piece. The front end of the document holder 200 has a transmissive document insertion portion 220, and the rear end of the document holder 200 has a hard insertion end 210. The document holder has a document carrying platform. The transmissive document insertion portion 220 of the document holder 200 has a transmissive document upper stopper 221, and a recessed through region 222 is disposed under the stopper.

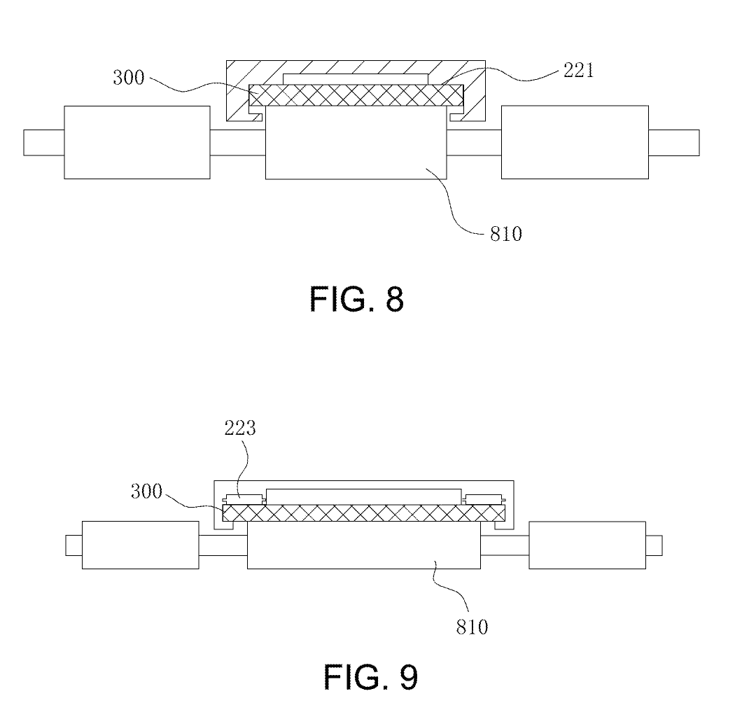

As indicated in FIG. 8, after the document holder 200 is inserted into the scanning apparatus, the feeding rollers 810 of the scanning apparatus can indirectly touch the upper stopper 221 to provide a force for driving the document 200.

In another embodiment, a number of driven feeding rollers 223 parallel to the feeding rollers are disposed on the lower end surface of the transmissive document upper stopper. After the document holder 200 is inserted into the scanning apparatus, the feeding rollers 810 and the driven feeding rollers 223 of the scanning apparatus can contact the transmissive document 200 by rolling to provide a stabler and smoother force for driving the document. Moreover, such design better protects the transmissive document, and avoids the surface of the transmissive document being scratched due to the friction between the transmissive document and the feeding assembly. The document holder facilitates the feeding of documents with the aid of feeding rollers, and conveniently implements the feeding of single-sheet document and continuous documents.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scanning method of scanning apparatus being a sheet-fed scanning apparatus having a reflective document scanning function and a transmissive document scanning function, wherein the scanning method comprises:
In a default state of the scanning apparatus being in a reflective document scanning state, placing a document in the scanning apparatus and then the scanning apparatus automatically activates the reflective document scanning function for performing scanning;
inserting a document holder to a feeding entrance of the scanning apparatus, and then the scanning apparatus activates a transmissive document scanning state and automatically activates the transmissive document scanning function to perform scanning after a document is placed in the document holder.

2. The scanning method of scanning apparatus according to claim 1, wherein the scanning method further comprises:
obtaining a sensing signal indicating that the document is already fed in and activating the reflective document scanning element by the scanning apparatus in the default state to perform reflective document scanning function after a document is placed into the scanning apparatus.

3. The scanning method of scanning apparatus according to claim 1, wherein the scanning method further comprises:
activating an activating member by the document holder after the document holder is placed in the feeding entrance of the scanning apparatus to further activate the scanning apparatus being in the transmissive document scanning state, wherein after the document is placed in the document holder, the document activates a sensing element, and the scanning apparatus activates a transmissive document scanning element to perform the transmissive document scanning function.

4. The scanning method of scanning apparatus according to claim 3, wherein the document holder has a hard insertion end disposed at the feeding entrance of the scanning apparatus, and the hard insertion end activates an activating member, which activates the transmissive document scanning function.

5. A scanning method of scanning apparatus being a sheet-fed scanning apparatus having a reflective document scanning function and a transmissive document scanning function, wherein the scanning method comprises the following steps:
activating the scanning apparatus which is in a default reflective document scanning state;
sensing by the scanning apparatus to determine whether a document holder is disposed in a feeding entrance;
If there is no document holder inserted into the feeding entrance, the scanning apparatus is determined as the reflective document scanning state, and when the scanning apparatus obtains a sensing signal indicating that the document is already fed in, the scanning apparatus activates a reflective document scanning element to perform the reflective document scanning function;
automatically setting the scanning apparatus to be in the transmissive document scanning state if there is a document holder inserted into the feeding entrance, wherein when the scanning apparatus obtains the sensing signal indicating that the document is already fed in, the scanning apparatus activates a transmissive document scanning element to perform transmissive document scanning function.

6. A scanning method of scanning apparatus being a sheet-fed scanning apparatus having a reflective document scanning function and a transmissive document scanning function, wherein the scanning method comprises:
In the default state of the scanning apparatus being in a reflective document scanning state, inserting a document holder into the feeding entrance of the scanning apparatus, and after the scanning apparatus activates a transmissive document scanning state and a document is placed in the document holder, the scanning apparatus automatically activates the transmissive document scanning function to perform scanning;
placing a reflective document in a carrier having a scanning recognition mark when scanning the reflective document, and when the scanning apparatus obtains the scanning recognition mark, the scanning apparatus activates the reflective document scanning function.

7. A scanning apparatus having a reflective document scanning element and a transmissive document scanning element, wherein the scanning apparatus comprises:
a set of feeding assembly comprising a plurality of feeding rollers and corresponding driven rollers;
a document holder whose one end has a transmissive document insertion portion and the other end has a hard insertion end;
an activating mechanism disposed at one side of the feeding assembly;
wherein, when the document holder is not inserted into the feeding assembly, the scanning apparatus is in a reflective document scanning state, and after the hard insertion end of the document holder is disposed in the feeding assembly, the document holder activates the activating mechanism for enabling the scanning apparatus to activate a transmissive document scanning function.

8. The scanning apparatus according to claim 7, wherein the activating mechanism, being a photo-electrical activating mechanism or a mechanical activating mechanism, is linked to a sensing element which is connected to a driving control unit of a scanning apparatus.

9. The scanning apparatus according to claim 8, wherein the activating mechanism comprises a flexible extension portion whose one end is located in a document holder inserting region at one side of the feeding assembly, and after the document holder is disposed in the flexible extension portion, the flexible extension portion is pressed downward to activate the sensing element to generate a sensing signal.

10. The scanning apparatus according to claim 7, wherein the document holder is a transmissive document holder whose the transmissive document insertion portion has a transmissive document upper stopper, a recess is disposed under the transmissive document upper stopper and matches the feeding rollers, and when the document holder is disposed in the feeding assembly, the feeding rollers and the transmissive document upper stopper together hold the transmissive document.

11. The scanning apparatus according to claim 10, wherein the driven feeding rollers parallel to the feeding rollers are disposed on the lower end surface of the transmissive document upper stopper, and when the document holder is disposed in the feeding assembly, the feeding rollers and the driven feeding rollers together hold the transmissive document.

12. The scanning apparatus according to claim 7, wherein the scanning apparatus further has a feeding entrance on which a document holder insertion portion is disposed, and the feeding assembly corresponding to the feeding entrance has a matching portion corresponding to the hard insertion end of the document holder.

13. The scanning apparatus according to claim 7, wherein the scanning apparatus have two sets of feeding assembly in parallel.
